(19) United States
(12) Patent Application Publication
(10) Pub. No.: US 2018/0327071 A1
(43) Pub. Date: Nov. 15, 2018

(54) SYSTEMS AND METHODS FOR AIRCRAFT INTEGRATED COMPOSITE FRAMES

(71) Applicant: The Boeing Company, Chicago, IL (US)

(72) Inventors: Michael Jason Bailey, Summerville, SC (US); Christopher D. Offensend, Seattle, WA (US)

(21) Appl. No.: 15/592,124

(22) Filed: May 10, 2017

(51) Int. Cl. B64C 1/06; B64C 1/12; B64C 1/26; B64F 5/10; B32B 5/02

(52) U.S. Cl. CPC B64C 1/061; B64C 1/12; B64C 2001/0072; B64F 5/10; B32B 5/02; B64C 1/26

(57) ABSTRACT

Systems and methods are provided for a variable web height aircraft composite structural beam. The variable web height aircraft composite structural beam can include a variable height web, a first flange located on an outer portion of the web, and a second flange located on an inner portion of the web. The variable height web is a first height in a first portion of the variable web height aircraft composite structural beam and a second height in a second portion thereof. The variable web height aircraft composite structural beam can be a structural beam of an aircraft.

### TECHNICAL FIELD

The disclosure relates generally to aircraft and more specifically to aircraft structures.

### BACKGROUND

Aircraft structures can be made from a variety of different materials. For example, current composite aircraft structures can include structural beams within the nose wheel well assembly in the forward fuselage section of an aircraft fuselage that mixes composite beams with titanium shear-ties and aluminum plates. The multiple components of different materials are needed as current composite beams are required to be manufactured with constant web heights and so cannot be manufactured with complex geometries. As the structural elements of the nose wheel well assembly requires such complex geometries, additional parts made from other materials are needed for a full beam assembly. However, the multiple components lead to higher costs, tolerance stack-ups, further points of maintenance, and a less rigid structure.

### SUMMARY

Systems and methods are disclosed for a variable web height aircraft composite structural beam and applications thereof. In a first example, an aircraft can be disclosed. The aircraft can include a fuselage that includes a plurality of beams, each beam disposed at a different lengthwise section of the aircraft. The plurality of beams includes at least one continuous beam and at least one discontinuous laminate composite structural beam. The discontinuous laminate composite structural beam can include a variable height web, a first flange located on an outer portion of the web, and a second flange located on an inner portion of the web, where the first flange and the second flange are separated by a first distance at a first portion of the laminate composite structural beam and separated by a second distance at a second portion of the laminate composite structural beam.

In a second example, a laminate composite aircraft structural beam can be disclosed. The laminate composite aircraft structural beam can include a variable height web, a first flange located on an outer portion of the web, and a second flange located on an inner portion of the web, where the first flange and the second flange are separated by a first distance at a first portion of the laminate composite aircraft structural beam and separated by a second distance at a second portion of the laminate composite aircraft structural beam.

In a third example, a method can be disclosed. The method can include mounting a ply on a ply carrier, loading the ply carrier into a robotic clamp arc forming tool, moving a forming head of the robotic clamp arc forming tool to a first portion of the ply, where the ply forms at least one layer of a laminate composite aircraft structural beam, and where the laminate composite aircraft structural beam comprises a variable height web, a first flange located on an outer portion of the web, and a second flange located on an inner portion of the web, forming the ply at the first portion, and where the first flange and the second flange are separated by a first distance at the first portion, moving the forming head to a second portion of the ply, and forming the ply at the second portion, where the first flange and the second flange are separated by a second distance at the second portion.

The scope of the invention is defined by the claims, which are incorporated into this section by reference. A more complete understanding of the disclosure will be afforded to those skilled in the art, as well as a realization of additional advantages thereof, by a consideration of the following detailed description of one or more implementations. Reference will be made to the appended sheets of drawings that will first be described briefly.

### BRIEF DESCRIPTION OF THE DRAWINGS

FIG. 1 illustrates a top view of an aircraft in accordance with an embodiment of the disclosure.

FIG. 2 illustrates a perspective view of an example aircraft structure in accordance with an embodiment of the disclosure.

FIG. 3 illustrates an example of a variable web height aircraft composite structural beam in accordance with an embodiment of the disclosure.

FIGS. 4A-C illustrate examples of an aircraft wheel well composite structure in accordance with an embodiment of the disclosure.

FIG. 5 is a flowchart detailing production of a variable web height aircraft composite structural beam in accordance with an embodiment of the disclosure.

Examples of the disclosure and their advantages are best understood by referring to the detailed description that follows. It should be appreciated that like reference numerals are used to identify like elements illustrated in one or more of the figures.

### DETAILED DESCRIPTION

Systems and techniques for variable height web composite frame beams are described in this disclosure. In certain examples, the systems and techniques described herein may be used for aircraft structure. The variable height web composite frame beam disclosed herein is a laminate composite structural beam that includes a variable height web with a first flange on one end of the web, and a second flange on another portion of the web. At different portions of the variable height web composite frame beam, the first flange and the second flange are separated by different distances.

Generally, certain aircraft structures (such as, for example, the structure proximate to the nose wheel well) are attached with a combination of beams, shear-ties, plates, and fasteners of different materials. Such combinations increase parts counts, allow for a greater amount of points of failure, decrease structural rigidity, and increase maintenance and assembly time. The laminate composite structural beam described herein allows for replacement of such combination of beams, shear-ties, plates, and fasteners with a single laminate composite structural beam.

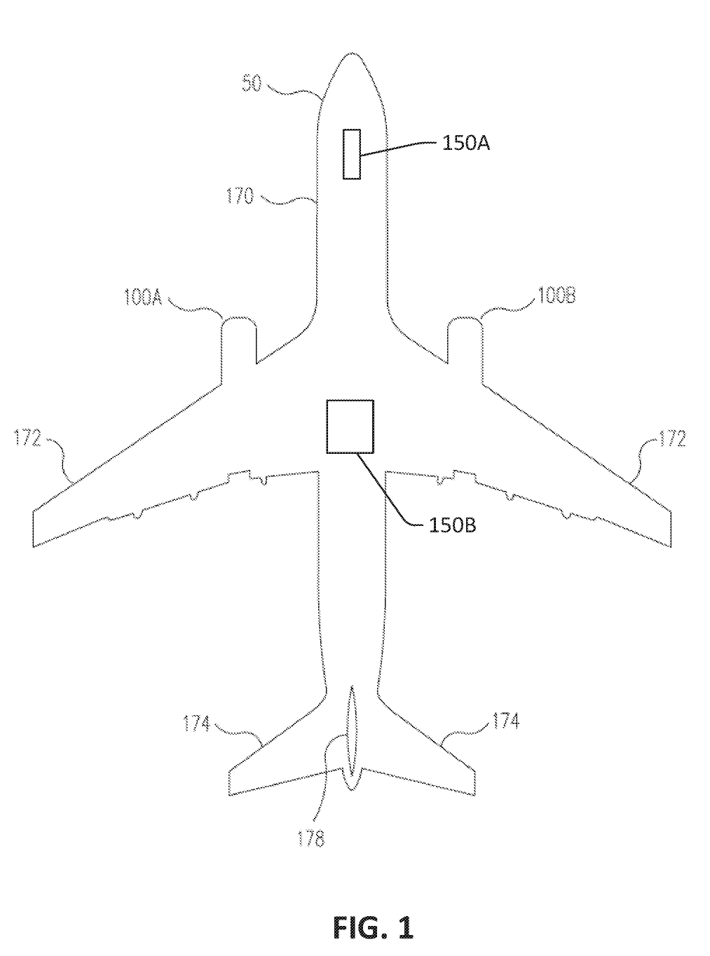

FIG. 1 illustrates a top view of an aircraft in accordance with an embodiment of the disclosure. The aircraft 50 of FIG. 1 includes a fuselage 170, wings 172, horizontal stabilizers 174, aircraft propulsors 100A and 100B, and a vertical stabilizer 178.

The aircraft 50 described in FIG. 1 is exemplary and it is appreciated that in other embodiments, the aircraft 50 may include less or additional components (e.g., no horizontal stabilizer, additional stabilizers, additional sensors, and/or additional controllers). Additionally, the structures and techniques described herein may be extended to other vehicles such as automobiles, watercrafts, and other aircrafts such as helicopters, Unmanned Aerial Vehicles, etc.

The aircraft propulsors 100A and 100B can be any type of propulsor such as turbofans, turboprops, turbojets, ramjets, and/or any other type of propulsor that produces thrust to move the aircraft 50. The wings 172, horizontal stabilizers 174, and vertical stabilizer 178 can produce lift and/or control movement of the aircraft 50. Certain other examples of aircraft can include any number of aircraft propulsors, wings, horizontal stabilizers, and/or vertical stabilizers.

The fuselage 170 is a fuselage that includes one or more composite beams. Certain other beams can also be composite or metallic (e.g., aluminum, titanium, steel, or another such metal). The fuselage 170 can, in certain examples, also include metallic and/or composite aircraft skin. The beams are coupled to the metallic skin, to each other, and/or to other components of the aircraft 50. At least some of the beams are used to form a load bearing structure of the aircraft 50.

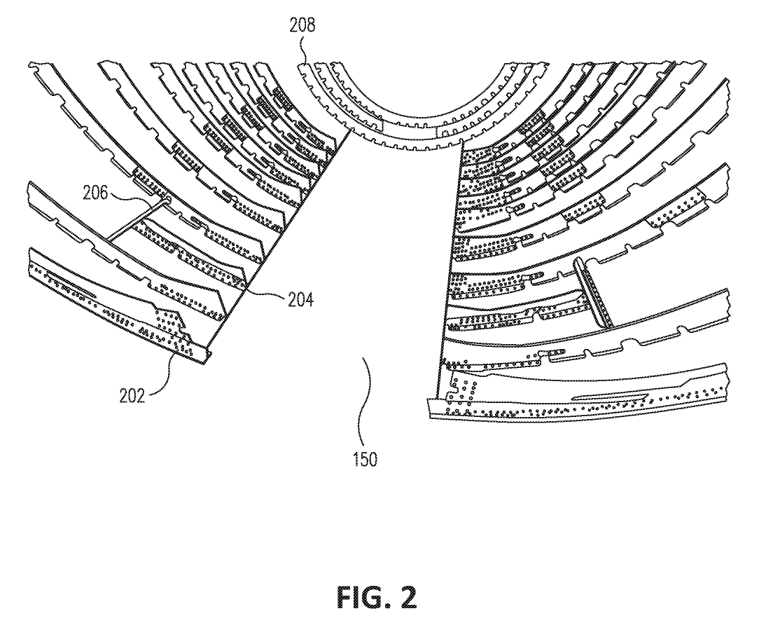

The fuselage 170 also includes wheel well openings 150A and 150B. The wheel well openings 150A and 150B are openings within the fuselage 170 that allow for landing gear and other components to be deployed. While certain beams of the fuselage 170 are continuous beams (e.g., they wrap around the inner circumference of a cross section of a section of the fuselage 170), other beams are discontinuous. The wheel well openings 150A and 150B can include one or more discontinuous laminate composite structural beams located proximate to the wheel well openings 150A and 150B. Such laminate composite structural beams are discontinuous due to the wheel well openings preventing the structural beams from fully wrapping around the circumference within the fuselage. The continuous and discontinuous laminate composite structural beams are illustrated in further detail in FIG. 2.

FIG. 2 illustrates a perspective view of an example aircraft structure in accordance with an embodiment of the disclosure. FIG. 2 shows the aircraft structure from inside the fuselage looking outwards. As such, FIG. 2 shows wheel well opening 150, discontinuous laminate composite structural beam 202, short beam 204, stringer 206, and continuous laminate composite structural beam 208. Discontinuous laminate composite structural beam 202, short beam 204, stringer 206, and continuous laminate composite structural beam 208 can form at least a portion of a structure of a fuselage (e.g., fuselage 170). Various other examples of the fuselage can include one or more other structural components.

The fuselage of an aircraft can be divided into a plurality of sections (e.g., divided into a plurality of lengthwise sections). Each section may include one or more continuous and/or discontinuous laminate composite structure beams to provide rigidity to the structure. The continuous laminate composite structural beam 208 can wrap around the inner circumference of a cross section of a portion of the fuselage. The discontinuous laminate composite structural beam 202 can, in certain examples, resemble an O shape. As such, for example, the continuous laminate composite structural beam 208 can be a continuous unbroken beam. Various examples of the continuous laminate composite structural beam 208 can be constructed from one component or a plurality (e.g., two, three, four, or five or more) of components. When the continuous laminate composite structural beam 208 is constructed from a plurality of components, the plurality of components may be coupled together via adhesives, welding, mechanical fasteners, and/or other such coupling techniques.

The wheel well opening 150 can be wheel well opening 150A or 150B shown in FIG. 1 or another such wheel well opening. Due to the wheel well opening 150, structural beams in the section of the fuselage proximate to the wheel well opening 150 cannot be continuous as there is an opening within the circumference of the fuselage. As such, discontinuous laminate composite structural beam 202 is used in the section of the fuselage around wheel well opening 150.

Discontinuous laminate composite structural beam 202 is a structural beam that wraps around a portion of the inner circumference of a cross section of the fuselage. The discontinuous laminate composite structural beam 202 can, in certain examples, resemble a C shape. The discontinuous portion of the discontinuous laminate composite structural beam 202 can accommodate the wheel well opening 150 and thus allow for deployment of landing gear and/or other components through the wheel well opening 150.

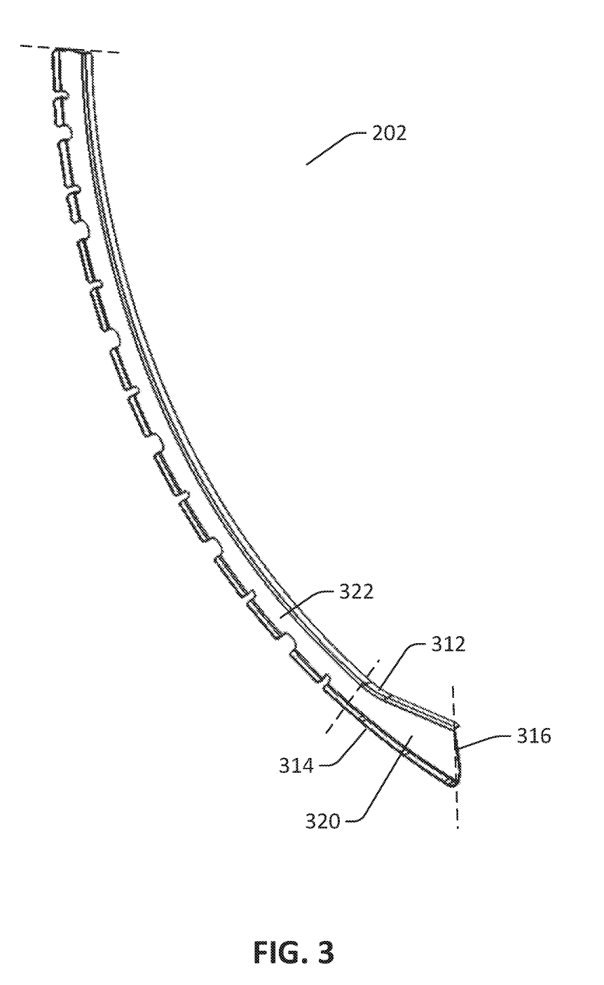

Various examples of the discontinuous laminate composite structural beam 202 can be constructed from one component or a plurality (e.g., two, three, four, or five or more) of components. When the discontinuous laminate composite structural beam 202 is constructed from a plurality of components, the plurality of components may be coupled together via adhesives, welding, mechanical fasteners, and/or other such coupling techniques. However, at least one such component of the discontinuous laminate composite structural beam 202 can include variable web height. Such variable web height is described in further detail in FIG. 3.

The short beam 204 can be another structural beam of the fuselage. The short beam 204 is coupled to stringer 206 and the stringer 206 can be coupled to the discontinuous laminate composite structural beam 202 and/or continuous laminate composite structural beam 208 to form the structure of the fuselage. In certain examples, the stringer 206, the short beam 204, and/or the continuous laminate composite structural beam 208 can also include variable web heights.

FIG. 3 illustrates an example of a variable web height aircraft composite structural beam in accordance with an embodiment of the disclosure. FIG. 3 shows the discontinuous laminate composite structural beam 202 of FIG. 2. As shown in

FIG. 3, the discontinuous laminate composite structural beam 202 includes a variable height web 316, a first flange 312 located on a first end of the web, and a second flange 314 located on a second end of the web. At least a portion of the first flange 312 can be configured to conform to an inner portion of the fuselage of the aircraft so that the discontinuous laminate composite structural beam 202 can attach to the skin of the fuselage to provide structural support.

As shown in FIG. 3, the discontinuous laminate composite structural beam 202 is a single piece produced from a composite (e.g., a combination or one or more of carbon fiber, Kevlar, fiberglass, resin, and/or other synthetic composites). As such, while discontinuous laminate composite structural beam 202 includes distinct features such as variable height web 316, first flange 312, and second flange 314, such distinct features may all be part of one component that is laid up from one or more composite plies.

In FIG. 3, the discontinuous laminate composite structural beam 202 includes a first portion 320 and a second portion 322. The variable height web 316 is a first height in the first portion 320, and is a second height different from the first height in the first portion 320. That is, the first flange 312 can be separated from the second flange 314 by a first distance in the first portion 320 and separated by a second distance in the second portion 322. In certain examples, the first portion and/or the second portion can include tapering parts within the portions of the web 316. That is, the height of the web 316 in such portions can change within the portion. FIG. 3 illustrates such an example as the first portion 320 tapers from one height to another height. However, though the first portion 320 tapers in FIG. 3, the height of at least part of the first portion 320 is still different from the height of at least part of the second portion 322.

While FIG. 3 illustrates a discontinuous laminate composite structural beam 202 with a first portion and a second portion, other examples of discontinuous laminate composite structural beams can include three or more portions and each of those portions can different heights. In certain other examples, at least two of those portions can be the same height (e.g., such an example would include portions of the ends of the discontinuous laminate composite structural beam that are the same height, but with a middle portion that is a different height).

The first flange 312 and the second flange 314 can, in certain examples, be parts of the discontinuous laminate composite structural beam 202 that are arranged in an orientation different from that of the variable height web 316. That is, as shown in FIG. 3, in a cross section of FIG. 3 along geometric plane 324A, the major length of the first flange 312 and the second flange 314 (e.g., the longer of the two sides that define the cross section of the first flange 312 and/or the second flange 314) are oriented approximately 90 degrees from that of the major length of variable height web 316 (e.g., the longer of the two sides that define the cross section of the web 316). Such an orientation can increase stiffness of the discontinuous laminate composite structural beam 202 and/or arrange certain surfaces of the discontinuous laminate composite structural beam 202 so that the discontinuous laminate composite structural beam 202 can be coupled to other portions of the aircraft. Other examples can orient the first flange 312, the second flange 314, and/or other flanges in different orientations (e.g., oriented 30, 45, 60, 120, 135, or 150 degrees from the web 316) or include discontinuous laminate composite structural beams of other geometries. In certain other examples, the discontinuous laminate composite structural beam can include 3-dimensionally varying geometry.

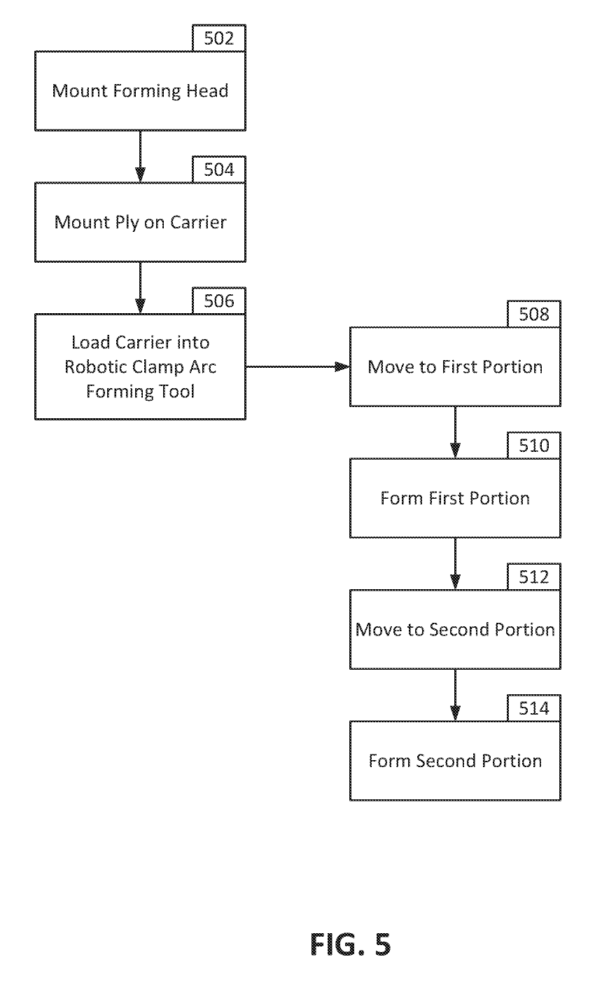

As shown in FIG. 3, the first flange 312 is located on an outer portion of the variable height web 316 and is configured to be installed on an aircraft closer to the aircraft fuselage than the second flange 314. As the variable height web 316 is curved, the first flange 312 can follow or substantially follow at least a portion of the curved portion of the variable height web 316. As such, the first flange 312 includes cut outs to allow for the first flange 312 to more easily bend to conform to the curvature of the variable height web 316. Other examples of the first flange 312 could not include such cut outs and the first flange 312 can then be constructed to bend along the curvature of the variable height web 316 via robotic clamp arc forming. Robotic clamp arc forming is described in further detail in FIG. 5.

The second flange 314 is located on an outer portion of the variable height web 316. The second flange 314 can also follow or substantially follow at least a portion of the curved portion of the variable height web 316. As shown in FIG. 3, the second flange 314 is unbroken (e.g., does not include the cut outs of first flange 312), but other examples of the second flange 314 can include cut outs.

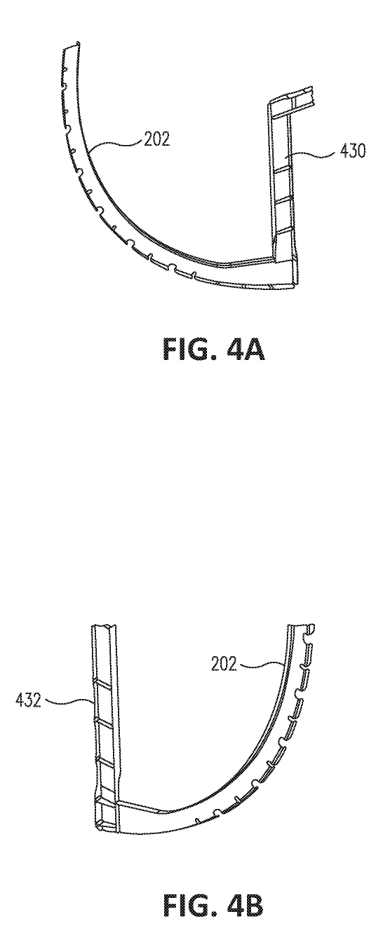

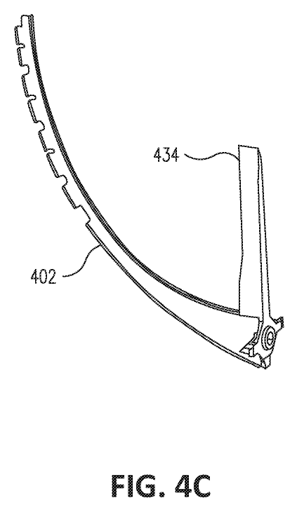

FIGS. 4A-C illustrate examples of an aircraft wheel well composite structure in accordance with an embodiment of the disclosure. In certain embodiments, the discontinuous laminate composite structural beam 202 can be coupled to one or more wheel well beams to further define a wheel well. Coupling the discontinuous laminate composite structural beam 202 to one or more wheel well beams can allow for the volume of the wheel well that contains the landing gear when the landing gear is in the retracted position to be defined.

FIGS. 4A-C illustrate three such example wheel well beams. As shown in FIGS. 4A-C, each discontinuous laminate composite structural beam 202 in FIGS. 4A-C is coupled to a wheel well beam that defines the vertical portion of the wheel well.

In FIG. 4A, the discontinuous laminate composite structural beam 202 is coupled to wheel well beam 430. Wheel well beam 430 is configured to be disposed on top of the variable height web of the discontinuous laminate composite structural beam 202.

In FIG. 4B, the discontinuous laminate composite structural beam 202 is coupled to wheel well beam 432. Wheel well beam 432 is configured to be disposed adjacent to an end of the discontinuous laminate composite structural beam 202.

In FIG. 4C, the discontinuous laminate composite structural beam 202 is coupled to wheel well beam 434. The wheel well beam 434 is configured to be disposed both on top of and adjacent to an end of the discontinuous laminate composite structural beam 202. The wheel well beam 434 additionally includes ribs and features that locate the wheel well beam 434 relative to the discontinuous laminate composite structural beam 202 to ensure correct positioning of the wheel well beam 434 relative to the discontinuous laminate composite structural beam 202.

The discontinuous laminate composite structural beam 202 can be coupled to the wheel well beam via any combination of adhesives, welding, mechanical fasteners, and/or other coupling techniques. The wheel well beam can be composite or metallic. While FIGS. 4A-C describe wheel well beams that are separate components from that of the discontinuous laminate composite structural beam 202, other examples can construct the discontinuous laminate composite structural beam 202 and the wheel well beam as one component (e.g., manufactured via, for example, robotic clamp arc forming to allow for a combined discontinuous laminate composite structural beam 202 and wheel well beam that includes variable web heights).

FIG. 5 is a flowchart detailing production of a variable web height aircraft composite structural beam in accordance with an embodiment of the disclosure. In block 502 of FIG. 5, a forming head is mounted on a robot, robotic arm, or a portion thereof. Additionally, a nosepiece configured to substantially match or form one or more local contours of a portion of the variable web height aircraft composite structural beam can also be attached to the forming head.

One or more plies that form the variable web height aircraft composite structural beam are placed in a designated position on a ply carrier in block 504. In block 506, the ply carrier is then loaded onto the robotic clamp arc forming tool. The ply carrier is then ready for layup, forming, and compaction operations.

In block 508, a portion of the robot, robotic arm, and/or tool is moved to a first portion of the variable web height aircraft composite structural beam to form the first portion or a feature of the first portion in block 510. In certain examples, the ply or plies are swept over a section of the tool to move the forming head over the tool to form a curvature of the first portion.

The portion of the robot, robotic arm, and/or tool is then moved to a second portion of the variable web height aircraft composite structural beam in block 512 to form the second portion or a feature of the second portion in block 514. The first portion and the second portion can include different or variable web heights.

Techniques and apparatuses used to produce variable web height aircraft composite structural beams are described in further detail in U.S. patent application Ser. No. 12/945,024 filed Nov. 12, 2010 and issued as U.S. Pat. No. 8,551,380, U.S. patent application Ser. No. 61/749,881 filed Jan. 7, 2013, U.S. patent application Ser. No. 13/736,021 filed Jan. 7, 2013, U.S. patent application Ser. No. 13/901,813 filed May 24, 2013 and issued as U.S. Pat. No. 9,314,974, U.S. patent application Ser. No. 14/525,500 filed Oct. 28, 2014, all of which are hereby incorporated by herein in their entirety.

Examples described above illustrate but do not limit the invention. It should also be understood that numerous modifications and variations are possible in accordance with the principles of the present invention. Accordingly, the scope of the invention is defined only by the following claims.

What is claimed is:

1. An aircraft comprising:
a fuselage comprising at least one laminate composite structural beam comprising:
a variable height web;
a first flange located on an outer portion of the web; and
a second flange located on an inner portion of the web, wherein the first flange and the second flange are separated by a first distance at a first portion of the laminate composite structural beam and separated by a second distance at a second portion of the laminate composite structural beam.

2. The aircraft of claim 1, wherein the laminate composite structural beam is a wheel well beam.

3. The aircraft of claim 2, wherein the first distance is greater than the second distance, wherein the first portion is adjacent to a wheel well opening of the fuselage, and wherein the second portion is disposed farther from the wheel well opening than the first portion.

4. The aircraft of claim 2, wherein the laminate composite structural beam further comprises a first end disposed near the first portion and the fuselage further comprises a side beam coupled to the first end.

5. The aircraft of claim 1, wherein the laminate composite structural beam is a discontinuous beam, and wherein the fuselage further comprises a continuous beam.

6. The aircraft of claim 1, wherein the fuselage further comprises a fuselage skin and at least a portion of the first flange conforms to an inner portion of the fuselage skin.

7. The aircraft of claim 1, wherein the laminate composite structural beam smoothly transitions between the first portion and the second portion.

8. The aircraft of claim 1, wherein the laminate composite structural beam is manufactured using at least robotic clamp arc forming.

9. The aircraft of claim 1, wherein the laminate composite structural beam comprises carbon fiber and resin.

10. The aircraft of claim 1, further comprising:
a wing coupled to the fuselage; and
an aircraft propulsor coupled to the wing and/or the fuselage.

11. A laminate composite aircraft structural beam comprising:
a variable height web;
a first flange located on an outer portion of the web; and
a second flange located on an inner portion of the web, wherein the first flange and the second flange are separated by a first distance at a first portion of the laminate composite aircraft structural beam and separated by a second distance at a second portion of the laminate composite aircraft structural beam.

12. The laminate composite aircraft structural beam of claim 11, wherein the laminate composite aircraft structural beam is configured to be disposed adjacent to an aircraft wheel well opening.

13. The laminate composite aircraft structural beam of claim 12, wherein the first distance is greater than the second distance and wherein the first portion is configured to be disposed adjacent to the aircraft wheel well opening.

14. The laminate composite aircraft structural beam of claim 13, wherein the second portion is configured to be disposed farther from the aircraft wheel well opening than the first portion.

15. The laminate composite aircraft structural beam of claim 11, wherein the laminate composite aircraft structural beam smoothly transitions between the first portion and the second portion.

16. The laminate composite aircraft structural beam of claim 11, wherein the laminate composite aircraft structural beam is manufactured using at least robotic clamp arc forming.

17. The laminate composite aircraft structural beam of claim 11, wherein the laminate composite aircraft structural beam comprises carbon fiber and resin.

18. A method comprising:
mounting a ply on a ply carrier;
loading the ply carrier into a robotic clamp arc forming tool;
moving a forming head of the robotic clamp arc forming tool to a first portion of the ply, wherein the ply forms at least one layer of a laminate composite aircraft structural beam, and wherein the laminate composite aircraft structural beam comprises a variable height web, a first flange located on an outer portion of the web, and a second flange located on an inner portion of the web;
forming the ply at the first portion, and wherein the first flange and the second flange are separated by a first distance at the first portion;
moving the forming head to a second portion of the ply; and
forming the ply at the second portion, wherein the first flange and the second flange are separated by a second distance at the second portion.

19. The method of claim 18, further comprising:
coupling the forming head to the robotic clamp arc forming tool.

20. The method of claim 18, wherein the ply is a composite resin ply.
